(19) United States
(12) Patent Application Publication
(10) Pub. No.: US 2017/0282315 A1
(43) Pub. Date: Oct. 5, 2017

(54) Device for Machining Turbine Parts

(71) Applicant: AeroHold, LLC, Morganton, NC (US)

(72) Inventor: Jeffrey B. Toner, Morganton, NC (US)

(73) Assignee: AeroHold, LLC, Morganton, NC (US)

(21) Appl. No.: 15/473,261

(22) Filed: Mar. 29, 2017

Related U.S. Application Data
(60) Provisional application No. 62/314,744, filed on Mar. 29, 2016.

(51) Int. Cl. B23Q 3/06; B23Q 3/08

(52) U.S. Cl. CPC B23Q 3/063; B23Q 3/082; F05D 2230/10

(57) ABSTRACT

A device for machining turbine parts includes a fixed base and an oppositely disposed adjustable base; first and second clamping plates, each of the clamping plates being with opposing sides of each of the fixed base and the adjustable base; a plurality of adjustable pins extending from the adjustable base in the direction of the fixed base; a plurality of work support pins extending from the fixed base in the direction of the adjustable base, each of the plurality of work support pins being in vertical alignment with a corresponding one of the plurality of adjustable pins; each of said plurality of adjustable pins and work support pins being structured and disposed for applying equivalent pressure at each surface point of the turbine part; a hydraulic system for actuating the clamping plates for securing the turbine part during the machining process.

### BACKGROUND OF THE INVENTION

This application is based on and claims priority to provisional patent application No. 62/314,744 filed on Mar. 29, 2016.

### FIELD OF THE INVENTION

This invention relates to a device for machining turbine parts and, more particularly, to a device for more precisely machining turbine parts according to print specifications.

### DISCUSSION OF THE RELATED ART

For many years, turbine parts used in aircraft jet engines have been manufactured using low temperature melting bismuth. The liquid bismuth conforms to the shape of the foil and, after cooling, serves to encapsulate the finish forged or finish machined airfoil surfaces. This process begins with the turbine part being placed inside a nest detail. The nest is a precision piece of tooling that is custom-designed to hold turbine parts. The encapsulation device used to locate the turbine part while the liquid bismuth is being poured thereon is custom-designed as well. After the bismuth solidifies, the encapsulation device is unclamped to permit removal of the turbine part. The loaded nest containing the turbine part is then placed in the precision machined jaws of a three-jaw hydraulic chuck and clamped. The chuck is a standard attachment that is bolted onto the spindle nose of a computer numerical controlled (CNC) lathe having the capability of milling features onto a part. The nest is engineered with two precise notches which are probed by the machine using a custom written program and a probing system. The spindle on the machine tool must be capable of rotating radially into position after probing for machining of the part.

While the process described above has been used for many years, it is not an efficient process due in part to the familiarity inherently required of each encapsulation device in order to keep the scrap part rate relatively low. Moreover, the process is not suitable for thin turbine parts as the heat generated from the bismuth often distorts the part in the nest. When the bismuth solidifies, the part is held in a stressed and/or distorted condition due to the heat. The part may also move within the nest while being machined in the z-axis direction. Once the part is machined, the bismuth is heated in order to release the part. If the part was held in a stressed condition, the part will spring back to its previous shape when unclamped. In these instances, the geometry of the newly machined features on the turbine part is not dimensionally accurate. Tolerance is provided on most drawings to allow for dimensional irregularities as long as the dimensions fall within the tolerance zone.

Therefore, with the foregoing reasons in mind, there exists a need in the art for a device to more precisely and more efficiently machine turbine parts according to print specifications.

### SUMMARY OF THE INVENTION

In accordance with one form of this invention, there is provided a device for machining turbine parts including a fixed base and an oppositely disposed adjustable base; first and second clamping plates, each of the clamping plates being with opposing sides of each of the fixed base and the adjustable base; a plurality of adjustable pins extending from the adjustable base in the direction of the fixed base; a plurality of work support pins extending from the fixed base in the direction of the adjustable base, each of the plurality of work support pins being in vertical alignment with a corresponding one of the plurality of adjustable pins; each of said plurality of adjustable pins and work support pins being structured and disposed for applying equivalent pressure at each surface point of the turbine part; a hydraulic system for actuating the clamping plates for securing the turbine part during the machining process.

### BRIEF DESCRIPTION OF THE DRAWINGS

For a fuller understanding of the nature of the present invention, reference should be made to the following detailed description, taken in conjunction with the accompanying drawings in which:

FIG. 1 is a front perspective view of the turbine blade holding fixture of the present invention;

FIG. 2 is a front elevational view, shown with partial cross-section cutouts, of the turbine blade holding fixture;

FIG. 3 is a rear perspective view of the turbine blade holding fixture;

FIG. 4 is a front elevational view of the turbine blade holding fixture with a turbine part secured thereon;

FIG. 5 is a top plan view of the turbine blade holding fixture;

FIG. 6 is a bottom plan view of the turbine blade holding fixture;

FIG. 7 is a top plan view of the fixed base of the turbine blade holding fixture;

FIG. 8 is a cross-sectional top plan view of the fixed base of the turbine blade holding fixture;

FIG. 9 is a top plan view of the adjustable base of the turbine blade holding fixture;

FIG. 10 is a perspective view of the lathe receiver fixture; and

FIG. 11 is a perspective view of the turbine blade holding fixture secured to the lathe receiver fixture.

Like reference numerals refer to like reference parts throughout the several views of the drawings.

### DETAILED DESCRIPTION OF THE PREFERRED EMBODIMENT

Referring to the several views of the drawings, the turbine blade holding fixture device of the present invention is shown and is generally indicated as 10. The device 10 is used in machining turbine parts 200.

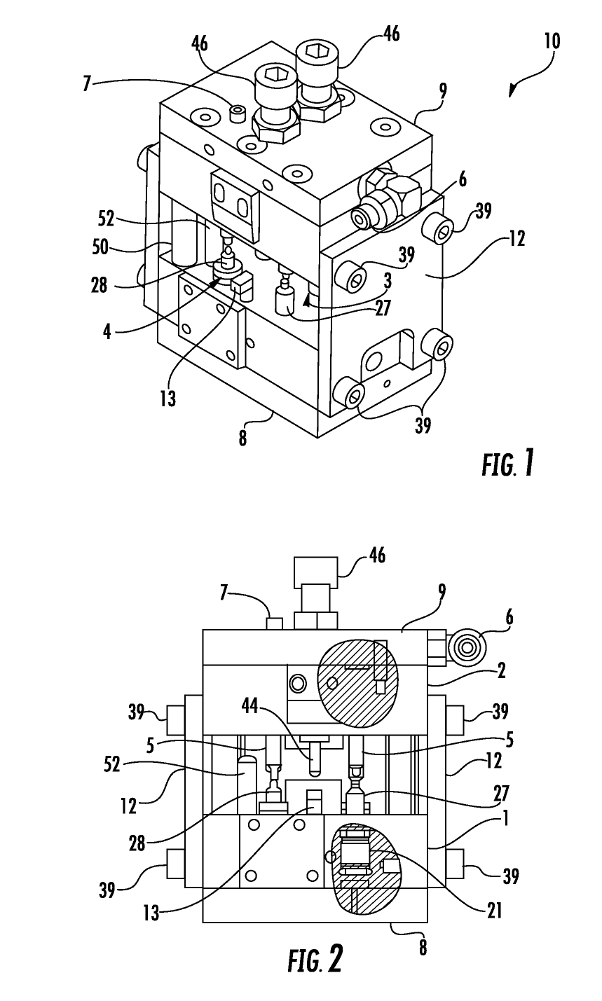

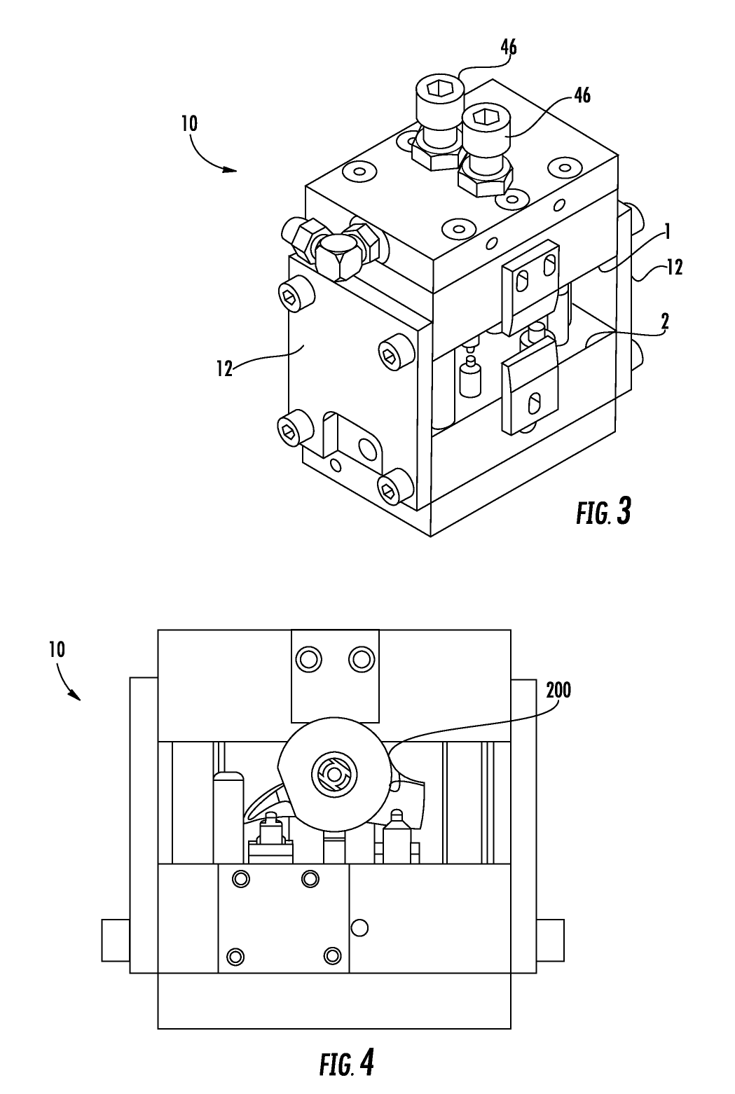

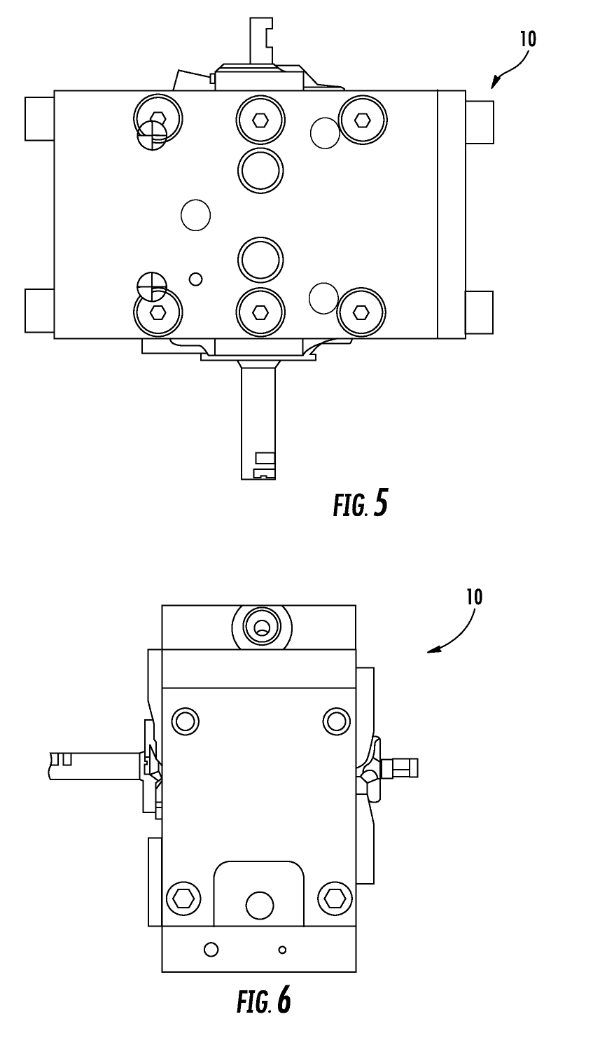

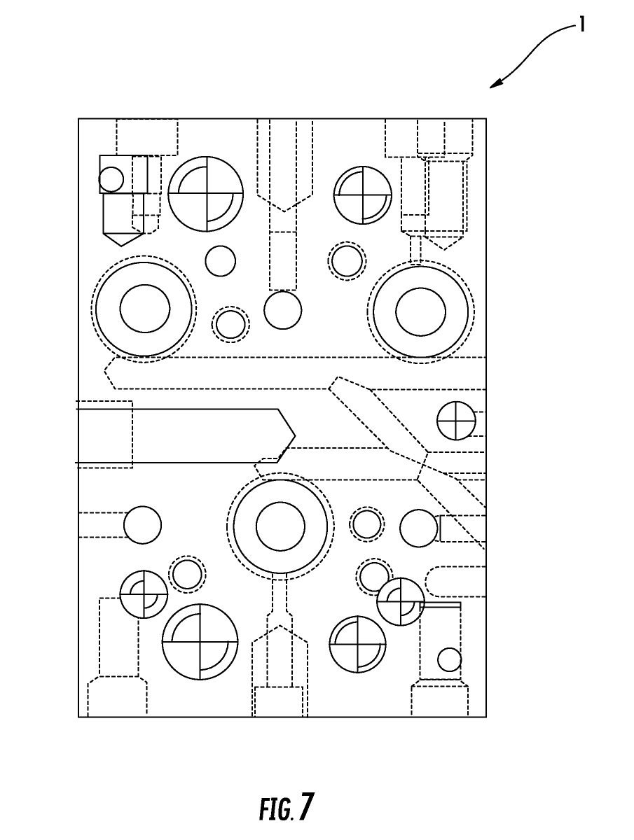

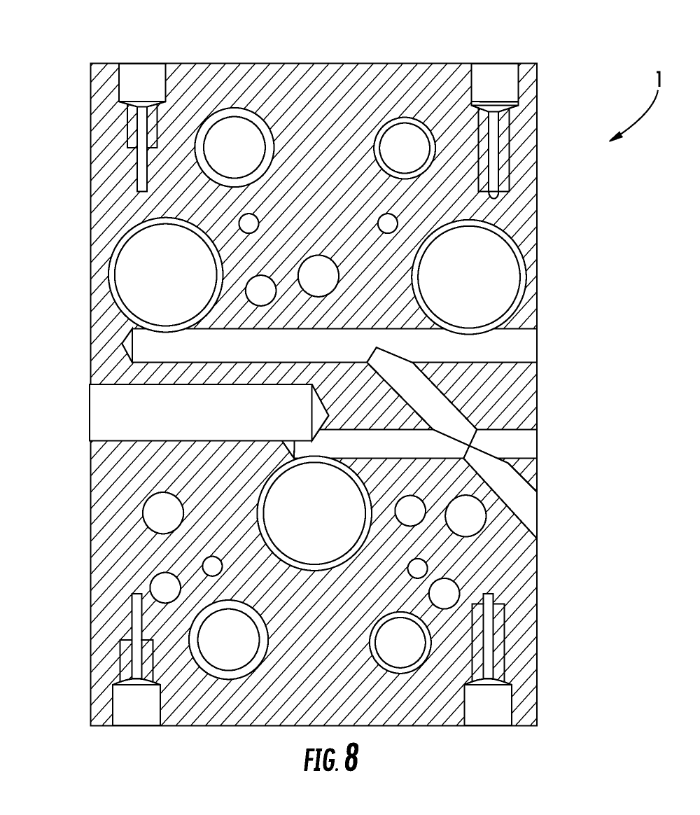

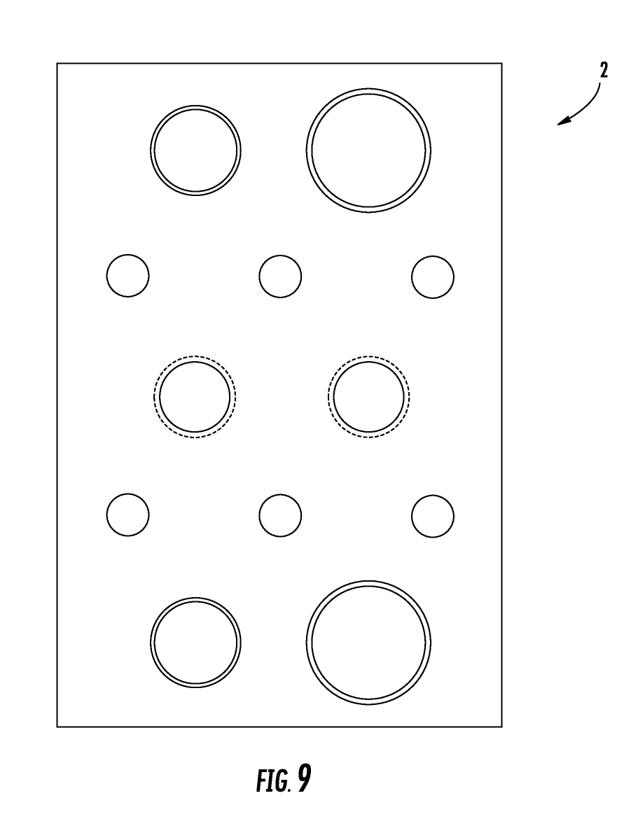

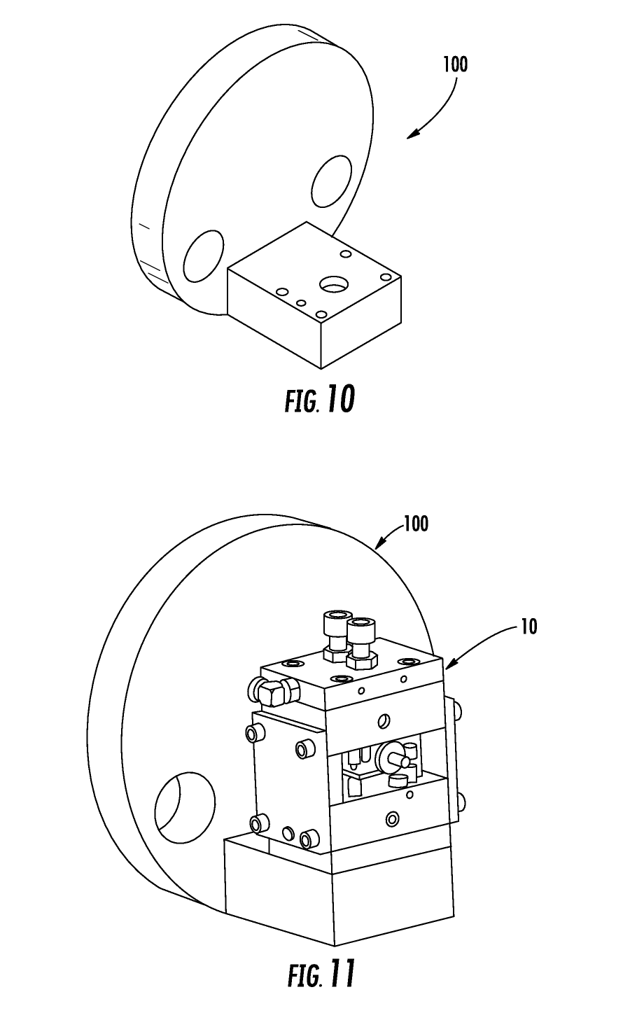

Referring to FIGS. 1-11, reference is made to the following parts listing

1—fixed base

2—adjustable base

3—short fixed pin

4—long fixed pin

5—adjustable pin

6—hydraulic fitting

7—pressure release screw

8—fixed base cap

9—adjustable base cap

10—turbine blade holding fixture device

12—clamping plate

13—datum stop

21—hydraulic lock sleeve

27—work support pin

28—work support pin

39—socket head cap screw (SHCS)

44—safety pin

46—compression spring

50—base stop

52—pull dowel pin

A standard datum structure scheme of 3-2-1 (primary, secondary and tertiary) was utilized. The primary datums locate three points on the complex foil geometry according to the print specifications. The secondary and tertiary datums locate the turbine part in the Y axis and Z axis positions respectively.

All datums on the device were precision machined so that they match the dimensions of the actual part. This is critical and was verified on a Coordinate Measuring Machine (CMM).

The device has an upper half and a lower half. The part is trapped between the two halves in a very precise manner and located according to the part's own datum structure, as explained above.

Preload was necessary to maintain the part's location prior to and during hydraulic clamping. In this case, the preload was accomplished using spring loaded adjustable pins. Large precision rods keep the two halves in alignment.

One hydraulic circuit was engineered so that the three clamping pins that were exactly opposite of the three (3) primary datums could be actuated with equal pressure. The secondary and tertiary datums do not have clamping force applied to them.

A second hydraulic circuit was engineered to clamp the two halves together. A very specialized hydraulic sleeve was utilized to maintain hydraulic pressure after the hydraulic system has been actuated and after the hydraulic fluid supply hoses were disconnected.

At this point, the turbine part is properly clamped and located according to its own datum structure. It is clamped at the appropriate hydraulic pressure. The clamping pressure will vary according to the part geometry.

1000 PSI is utilized for the clamping halves and 800 PSI for the clamping pins. The hydraulic pressure may be adjusted after more test machining of the turbine part. The clamping halves need to be more powerful (1000 PSI) than the clamping pins (800 PSI) so that the clamping pins do not overpower the clamping halves.

In order to machine the ends of the turbine part, a lathe receiver fixture 100 is engineered and built to accept the device 10. This fixture is located and mounted to the spindle nose of the mill/turn machine too.

The lathe receiver fixture is carefully designed so the centerline of the outside diameters on the turbine part are in line with the machine tool's centerline. The device is precision located and bolted onto the lathe receiver fixture. After one side of the turbine shaft is machined, the device is rotated one hundred eighty degrees (180°) so the opposite end of the part can be machined.

After the second side of the turbine part is finished being machined, the device is unbolted from the lathe receiver fixture. In order to keep the machine running and reduce spindle downtime, an identical device that already has a turbine part properly located and clamped is loaded onto the lathe receiver fixture and secured.

The part change time should be no more than two (2) minutes if the operator is properly trained and an air clamp/unclamp tool with a pre-set torque setting is utilized.

The receiver fixture 100 is installed onto the CNC lathe. The receiver fixture 100 is then checked for proper alignment utilizing a 0.0005 indicator. The bolts will need to be properly torqued at the required foot pounds for a ⅜-16 Socket Head Cap Screw. For efficient use of the device 10, two identical devices 10 for each distinct turbine blade part number should be available at the machine. This will allow for the turbine blade (unmachined) to be loaded into the device with as little machine downtime as possible. The turbine blade part 200 will be unloaded and loaded on the workbench while the device 10 is machining a part using the second fixture. A bench top receiver fixture will be bolted to the bench within a few feet of the CNC machine. The adjustable pins 5 clamp the part at strategic points on the turbine blade, as it is imperative that the clamping pressure be the same on every part. The exact pressure will be dependent on the design and geometry of that particular part. 1,000 p.s.i. is the approximate pressure. The compression springs 46 are used to apply spring pressure to the turbine blade during the reloading of the device

Use of the device includes the following steps:

Step 1—Once the device is removed from the receiver fixture (on machine), it will be placed into the bench top receiver fixture.

Step 2—Hydraulic hoses using quick change connections (hydraulic fitting 6) will be connected to the hydraulic system of the device. The hydraulic screw pump will be actuated and cause the hydraulic pressure to de-pressurize. Without the hydraulic pressure, the clamping elements will retract into their respective housings. The part 200 will be unclamped at this point.

Step 3—Two 5/16-18 S.H.C.S. 39 will be unbolted and the adjustable base assembly 2 will be removed from the device 10.

Step 4—Using shop pressurized air the device is blown off to remove any metal shavings that could hinder the device from having a new part loaded.

Step 5—A new turbine blade part 200 is placed into the nest of the fixed base 1. The part 200 is moved around so that it is properly located against the predetermined datums.

Step 6—The adjustable base assembly 2 is reassembled onto the device while taking care that the part maintains its alignment onto the datums. The adjustable base assembly 2 has reassembly-assist details designed to allow for easy assembly.

Step 7—bolts are re-checked for proper torque.

Step 8—The device is now ready to be assembled onto the receiver fixture 100 once the other part is completed and the machine stops.

While the present invention has been shown and described in accordance with several preferred and practical embodiments, it is recognized that departures from the instant disclosure are contemplated within the spirit and scope of the present invention.

What is claimed is:

1. A device for machining turbine parts, said device comprising:
a fixed base and an oppositely disposed adjustable base;
first and second clamping plates, each of the clamping plates being with opposing sides of each of the fixed base and the adjustable base;
a plurality of adjustable pins extending from the adjustable base in the direction of the fixed base;
a plurality of work support pins extending from the fixed base in the direction of the adjustable base, each of the plurality of work support pins being in vertical alignment with a corresponding one of the plurality of adjustable pins;
each of said plurality of adjustable pins and work support pins being structured and disposed for applying equivalent pressure at each surface point of the turbine part;
a hydraulic system for actuating the clamping plates for securing the turbine part during the machining process.
